(19) United States
(12) Patent Application Publication
(10) Pub. No.: US 2006/0225259 A1
(43) Pub. Date: Oct. 12, 2006

(54) PIEZOELECTRIC VIBRATION PLATE

(76) Inventors: Chih-Chang Tsai, Kao-Hsiung City (TW); Chih-Ming Chen, Miao- Li Hsien (TW)

Correspondence Address: NORTH AMERICA INTELLECTUAL PROPERTY CORPORATION, P.O. BOX 506, MERRIFIELD, VA, 22116, US

(21) Appl. No.: 11/160,774

(22) Filed: Jul. 8, 2005

(30) Foreign Application Priority Data
Apr. 12, 2005 (TW) 094111472

(51) Int. Cl. H04R 17/00

(52) U.S. Cl. 29/25.35

(57) ABSTRACT

A method includes providing a vibration plate and a piezoelectric ceramic, bonding the vibration plate and the piezoelectric ceramic, grinding the vibration plate and the piezoelectric ceramic, and forming the piezoelectric vibration plate by dicing the vibration plate and the piezoelectric ceramic.

### BACKGROUND OF INVENTION

1. Field of the Invention

The present invention relates to a method of manufacturing a piezoelectric vibration plate, and more particularly, to a method of manufacturing a wide-format piezoelectric vibration plate.

2. Description of the Prior Art

There are two major types of printers available in the consumer market: inkjet printers and laser printers. Laser printers have good printing quality and printing speed. However, due to higher manufacturing costs, lasers printers are much more expensive than inkjet printers. The price differences are especially apparent with color laser printers. As a result, color laser printers are more suitable for applications in large companies where large amount of printing is required, while most individual or household users choose inkjet printers.

According to methods of ejecting ink, inkjet printers can generally be categorized into two types: piezoelectric inkjet printers and thermal bubble inkjet printers. In thermal bubble inkjet printers, when the ink channel is heated, the ink stored in the ink chamber vaporizes and forms bubbles that provide the pressure required for ejecting ink from the nozzle. Though thermal bubble inkjet printers have low manufacturing costs, the lifetime of the print heads of the thermal bubble printers is very short since constant heating is required. The high-temperature ink-driving mechanism also limits the choices of ink materials, and thus limits the applications of the thermal bubble inkjet printers.

The printing technology of piezoelectric printers is based on piezoelectricity. Piezoelectricity is a coupling between a material's mechanical and electrical behaviors. In the simplest of terms, when a piezoelectric material is squeezed, an electric charge collects on its surface. Conversely, when a piezoelectric material is subjected to a voltage drop, it mechanically deforms. Common materials for piezoelectric printers are lead zirconate titanate (PZT), Barium Titanate (BaTiO3), Lead Titanate (PT) and lead magnesium niobate(PMN). The print head of a piezoelectric printer is similar to a piezoelectric system formed by piezoelectric materials that change dimensions according to the applied voltage. When a voltage is applied to a piezoelectric vibration plate of the print head, the piezoelectric vibration plate deforms, squeezes the ink stored in the ink chamber, and ejects the ink out of the nozzle of the print head. When the applied voltage drops, the piezoelectric vibration plate resumes its original dimension, separating ink stored in the ink chamber from the ink droplet being ejected and refilling ink into the ink chamber by capillarity. The vibrating frequency of the piezoelectric vibration plate affects the ink ejection rate. The size of ejected ink droplets depends on the applied voltage. Since the ink stored in the print head of the piezoelectric inkjet printer does not need to be heated and vaporized, piezoelectric inkjet printers can adopt various kinds of ink and can be applied to digital printing, the packing industry, the textile industry or commercial printing. Also, piezoelectric inkjet printers control the purity and sizes of the ejected ink droplets by precise control of applied voltages. Therefore, piezoelectric inkjet printers can provide better printing quality.

The print head of a piezoelectric inkjet printer has a multi-layer piezo (MLP) structure in which the piezoelectric vibration plate is formed with electrodes and piezoelectric materials in an alternative fashion. Common materials for making piezoelectric vibration plates of print heads in piezoelectric inkjet printers include metal, ceramic, high-polymeric or composite materials, each having advantages and disadvantage when used in piezoelectric inkjet printers. For example, metal materials have high reaction speed but poor deformation ability, while high-polymeric materials have good deformation ability but low reaction speed. In the prior art, piezoelectric vibration plates of piezoelectric inkjet printers are generally manufactured in a complicated and expensive process called a “ceramic co-fired” process. Simply speaking, in a ceramic co-fired process, multiple layers are combined by co-firing under high temperature and high pressure. Piezoelectric printers with print heads manufactured in the ceramic co-fired process have the following drawbacks:

(1) Print heads of piezoelectric printers have very small dimensions and delicate structures. Extremely precise alignment between multiple layers in the ceramic co-fired process is required before the final co-firing combination. The complexity and difficulty of the ceramic co-fired process reduces the manufacturing yield of print heads.

(2) Due to the complicated structures of the print heads, each layer of the piezoelectric vibration plates can suffer unbalanced deformation during the high-temperature and high-pressure combination and can thus influence the integrity of the entire print head structure.

(3) The unbalanced deformation mentioned in drawback (2) also results in mismatches between different layers of the piezoelectric vibration plates. Theses mismatches not only lower the manufacturing yield of the print heads, they also impact the compactness of the print heads, and thus lower the printing resolution of the piezoelectric printers.

The prior art piezoelectric vibration plate is manufactured in a ceramic co-fired process that is costly, complicated and suffers low production yield. Also, in the prior art ceramic co-fired process, the piezoelectric vibration plate suffers from cracks, unbalanced deformations and mismatches that influence the integrity of the entire print head structure.

### SUMMARY OF INVENTION

It is therefore a primary objective of the claimed invention to provide a method of manufacturing a piezoelectric vibration plate in order to solve the above-mentioned problems.

Briefly described, the present invention discloses a method of manufacturing a piezoelectric vibration plate comprising connecting a vibration plate and a piezoelectric ceramic using a diffusion bonding process or a gel bonding process.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 shows a flow chart illustrating a method of manufacturing a piezoelectric vibration plate according to the present invention.

FIG. 2 through FIG. 7 are cross-sectional diagrams corresponding to steps 100 through 600 depicted in FIG. 1.

FIG. 8 is a diagram showing a piezoelectric vibration plate and a nozzle plate.

### DETAILED DESCRIPTION

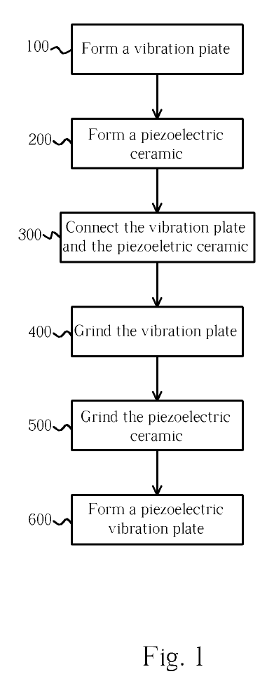

Please refer to FIG. 1 for a flow chart illustrating a method of manufacturing a piezoelectric vibration plate 10 according to the present invention. FIG. 1 includes the following steps:

Step 100: form a vibration plate 12;

Step 200: form a piezoelectric ceramic 14 by forming a piezoelectric layer 26 and two electrodes 22 and 24 on a substrate 11, the piezoelectric layer 26 being formed between the two electrodes 22 and 24;

Step 300: connect the vibration plate 12 and the piezoelectric ceramic 14;

Step 400: grind the vibration plate 12;

Step 500: grind the piezoelectric ceramic 14;

Step 600: form the piezoelectric vibration plate 10 by cutting the vibration plate 12 and the piezoelectric ceramic 14.

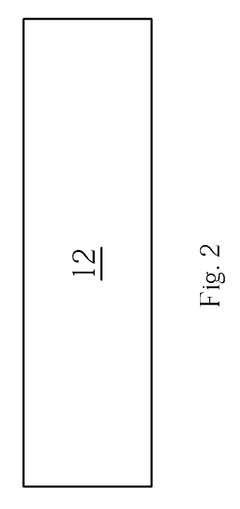

Please refer to FIG. 2 through FIG. 7 for cross-sectional diagrams corresponding to steps 100 through 600 depicted in FIG. 1, respectively.

FIG. 2 shows the vibration plate 12 formed in step 100;

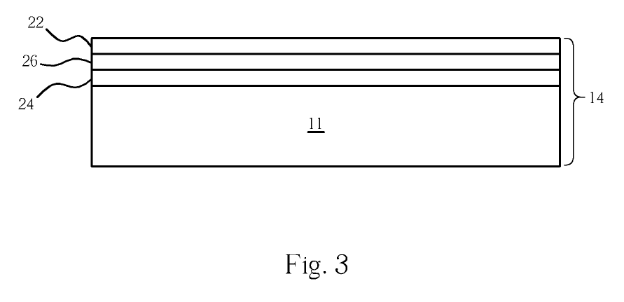

FIG. 3 shows the piezoelectric ceramic 14 formed in step 200;

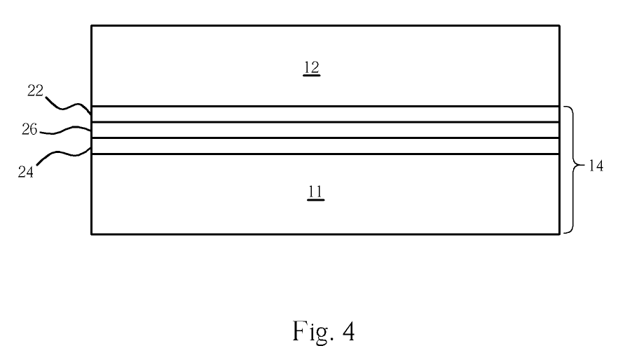

FIG. 4 shows the vibration plate 12 and the piezoelectric ceramic 14 after step 300;

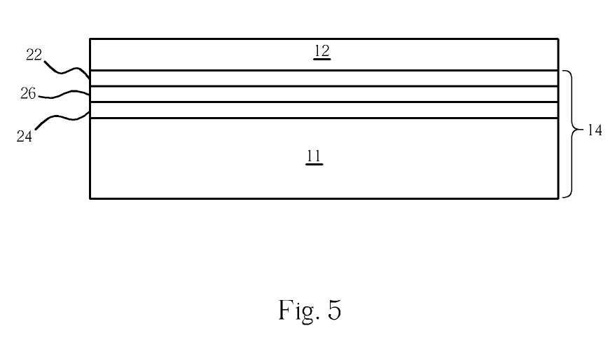

FIG. 5 shows the vibration plate 12 and the piezoelectric ceramic 14 after step 400;

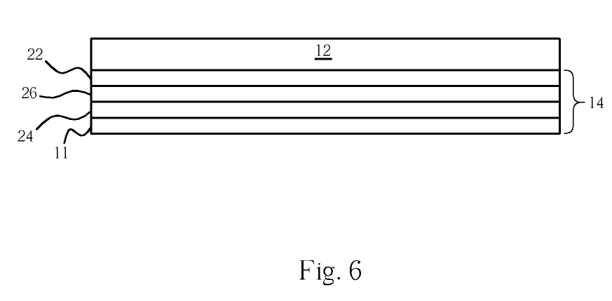

FIG. 6 shows the vibration plate 12 and the piezoelectric ceramic 14 after step 500;

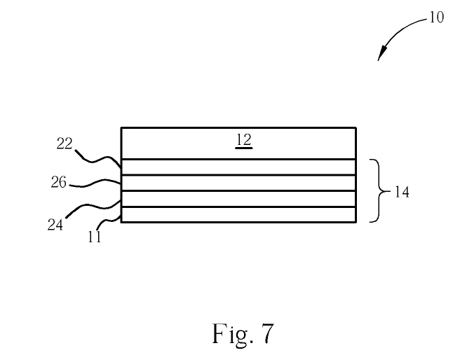

FIG. 7 shows the piezoelectric vibration plate 10 after step 600.

Step 300 depicted in FIG. 1 and FIG. 4 can adopt a gel bonding technology, in which gel is used for connecting the vibration plate 12 and the piezoelectric ceramic 14, or a diffusion bonding technology based on the solid-state diffusion and the interface interaction mechanisms of the materials. In the diffusion bonding technology, different layers are connected naturally by applying pressure and temperature below the melting point of the layers. By applying adequate pressure and temperature in step 300, the atomic bonding mechanism of interfaces of the vibration plate 12 and the piezoelectric ceramic 14 are changed in a way that the vibration plate 12 and the piezoelectric ceramic 14 are connected.

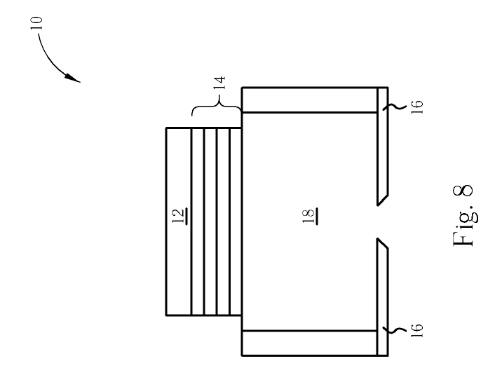

The piezoelectric vibration plate 10 formed in step 600 can be connected with a nozzle plate 16 and form an ink chamber 18 for storing ink in subsequent steps. Please refer to FIG. 8 for a diagram of the piezoelectric vibration plate 10 and the nozzle plate 16.

The prior art piezoelectric vibration plate is manufactured in a ceramic co-fired process that is costly, complicated and suffers low production yield. Also, in the prior art ceramic co-fired process, the piezoelectric vibration plate suffers from cracks, unbalanced deformations and mismatches that result in low production yield and influence the integrity of the entire print head structure. When being applied to the piezoelectric vibration plates for wide-format printers, the prior art method is particularly disadvantageous, having cracks and mismatches due to larger plate sizes. The present invention adopts grinding and connecting techniques that are simple, inexpensive and have high production yield. By connecting the vibration plate and the piezoelectric ceramic, either by gel bonding, diffusion bonding, or other bonding technologies, grinding the vibration plated and the piezoelectric ceramic, and forming the piezoelectric vibration plate by cutting the vibration plate and the piezoelectric ceramic, the cracks, unbalanced deformations and mismatches of the prior art can be avoided. The present invention is particularly suitable for applications on wide-format printers with the thickness of the piezoelectric vibration plate larger than 5 um.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of manufacturing a piezoelectric vibration plate comprising:
connecting a vibration plate and a piezoelectric ceramic using a diffusion bonding process.

2. The method of claim 1 further comprising grinding the vibration plate.

3. The method of claim 1 further comprising grinding the piezoelectric ceramic.

4. The method of claim 1 further comprising cutting the vibration plate and the piezoelectric ceramic.

5. The method of claim 4 further comprising disposing the cut vibration plate and the piezoelectric ceramic on a nozzle plate.

6. The method of claim 1 further comprising forming the piezoelectric ceramic by combining two electrodes and a piezoelectric layer.

7. A method of manufacturing a piezoelectric vibration plate comprising:
connecting a vibration plate and a piezoelectric ceramic using a gel bonding process.

8. The method of claim 7 further comprising grinding the vibration plate.

9. The method of claim 7 further comprising grinding the piezoelectric ceramic.

10. The method of claim 7 further comprising cutting the vibration plate and the piezoelectric ceramic.

11. The method of claim 7 further comprising disposing the cut vibration plate and the piezoelectric ceramic on a nozzle plate.

12. The method of claim 7 further comprising forming the piezoelectric ceramic by combining two electrodes and a piezoelectric layer.
